(19) United States
(12) Patent Application Publication
(10) Pub. No.: US 2002/0047414 A1
(43) Pub. Date: Apr. 25, 2002

(54) Machine

(76) Inventor: Roger Edward Latimer, Auckland (NZ)

Correspondence Address: YOUNG & THOMPSON, 745 SOUTH 23RD STREET 2ND FLOOR, ARLINGTON, VA, 22202

(21) Appl. No.: 09/833,596

(22) Filed: Apr. 13, 2001

(30) Foreign Application Priority Data
Apr. 13, 2000 (NZ) 503922

(51) Int. Cl. H02K 7/20; H02K 17/44; H02K 19/38

(52) U.S. Cl. 310/112; 310/166

(57) ABSTRACT

The invention comprises a motor driven machine, the machine such as a lathe, drill, router, saw, or shaping tool includes a machine spindle and a switch reluctance motor having a motor spindle. The construction is such that the longitudinal axis of the motor spindle and the longitudinal axis of the machine spindle lie on substantially the same axis. In one form of the invention the machine spindle and motor spindle can be unitary.

This invention relates to a machine and has been devised particularly for use in machines in the nature of a lathe or similar equipment.

In conventional machines such as a lathe a motor is provided mounted on the bed of the lathe and this motor is utilised to drive a head stock spindle usually by means of a belt and pulley between the spindle and the motor. Thus separate housings are required for the head stock and the motor. Also the motors that are used, particularly in smaller lathes, do not provide high torque at low power. Both of these factors are disadvantageous.

It is an object of the present invention to provide a machine which will obviate or the foregoing disadvantages in a simple yet effective manner or which will at least provide the public with a useful choice.

Accordingly the invention consists in a motor driven machine, the machine including a machine spindle and a switch reluctance motor having a motor spindle, the construction being such that the longitudinal axis of the motor spindle and the longitudinal axis of the machine spindle lie on substantially the same axis.

Preferably the machine is a lathe and the lathe includes a bed and a headstock, the longitudinal axis of the motor spindle and the longitudinal axis of the head stock spindle lying on substantially the same axis.

Preferably the head stock spindle and the motor spindle comprise a single spindle.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

One preferred form of the invention will now be described with reference to the accompanying drawings in which,

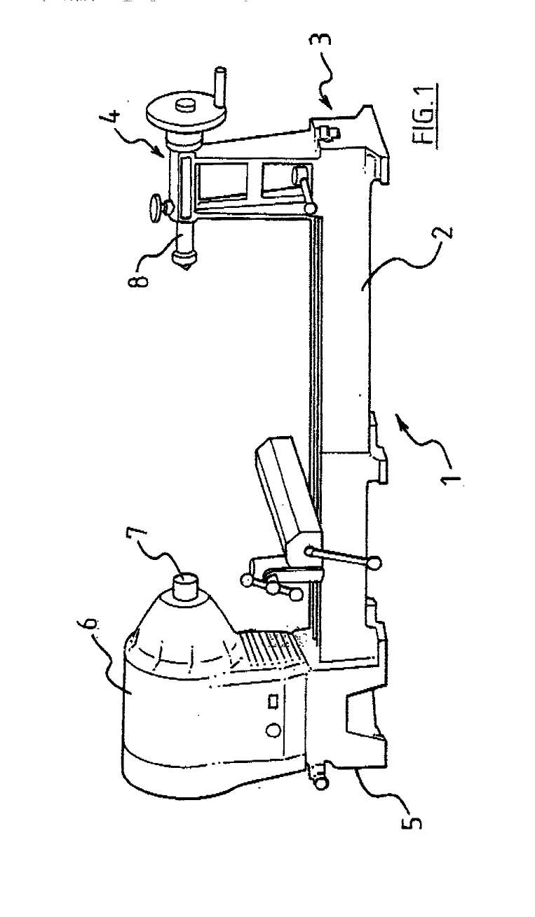

FIG. 1 is a perspective view of a machine in the form of a lathe according to one preferred form of the invention, and

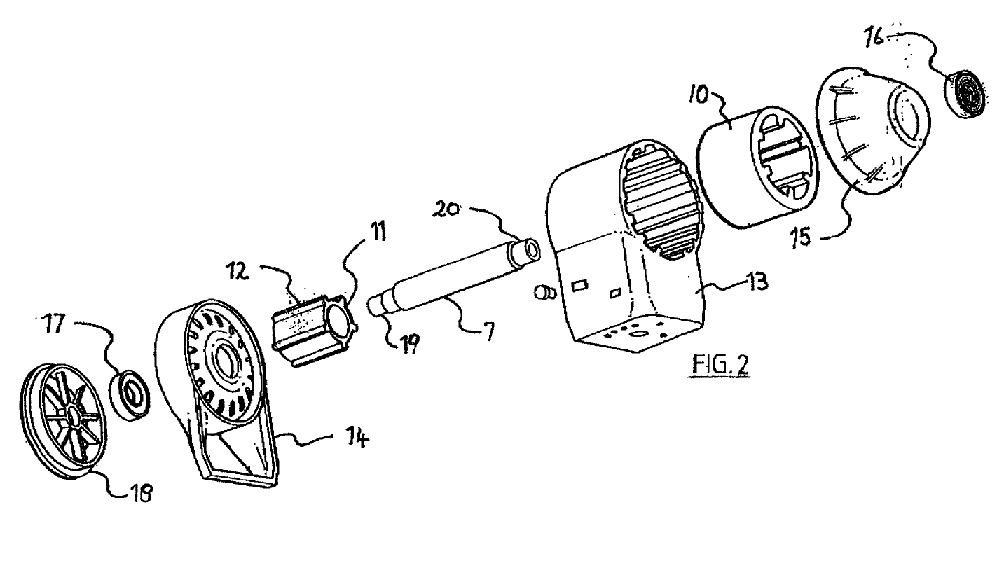

FIG. 2 is an exploded view of one form of motor suitable for use in the invention of FIG. 1, and

FIGS. 3 to 5 are simplified perspective views of alternative machines.

Referring to the drawings, a machine which is motor driven and has a machine spindle is provided. A typical example of such a machine is a lathe. Accordingly a lathe 1 is provided which has a bed 2. Toward one end 3 of the lathe 1 are provided the usual mounting and clamping mechanisms indicated generally at 4.

At the other end 5 of the lathe 1 is provided a motor 6 which is mounted above the lathe bed 2.

The motor 6 provides a spindle 7 the longitudinal axis of which lies substantially on the same axis as the longitudinal axis of the spindle 8 forming part of the apparatus at 4.

The longitudinal axis of the spindle 7 which is a head stock spindle, lies also on substantially the same axis as the longitudinal axis of the spindle of the motor 6 and in the preferred embodiment the head stock spindle and the motor spindle comprise a single spindle 7.

The motor 6 is a switch reluctance motor which provides a stator 10 carrying the windings and a rotor 11 carrying outwardly extending longitudinal ribs such as 12.

The motor also comprises suitable casing components 13, 14 and 15 as well as bearings 16, and 17 and a back plate 18 which carries the end 19 of the spindle 7 opposite the end 20 which provides the head stock spindle.

A switch reluctance motor is suitable as this type of motor is able to provide good speed control with adequate torque across a range of speeds including low speeds.

FIG. 3 shows a drilling, routing or moulding machine 25 having a drill bit or the like 26 again on the machine axis, and which may be integrated with the motor spindle.

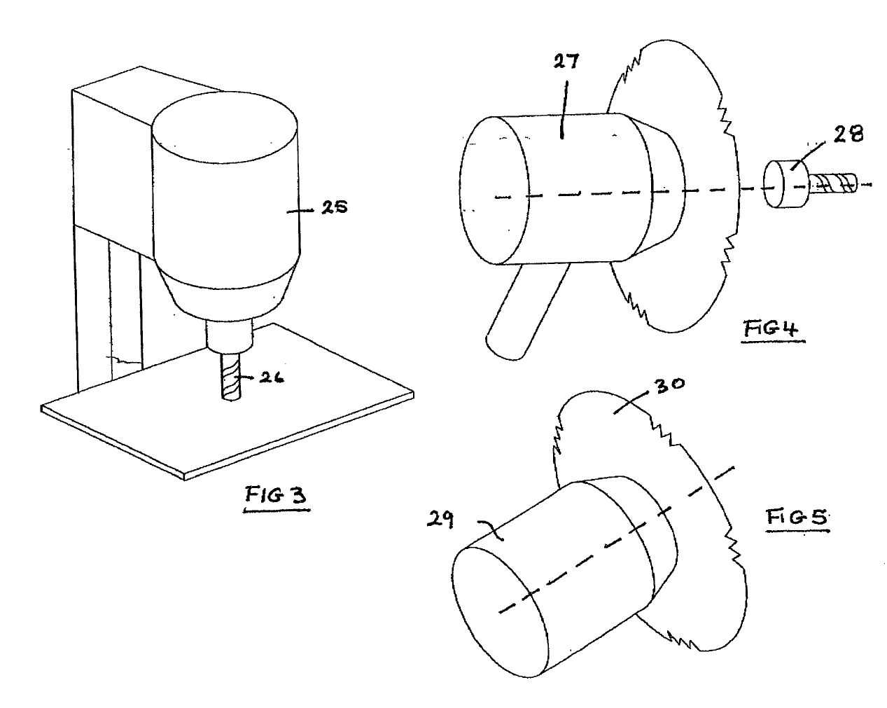

FIG. 4 shows a drilling, shaping or routing machine 27 in which the bit 28 is separate but engages the motor spindle or an elongation thereof.

In FIG. 5 the machine 29 is a saw, the centre or boss of the blade 30 being engageable with machine spindle or an elongation thereof.

In use the machine, particularly the lathe of the invention, is simply used in the known manner. With the work piece clamped between the spindle 8 and the head stock spindle 7, the motor is operated to rotate the work piece to enable shaping of the work piece, usually of metal or wood, to take place.

Thus particularly in the preferred form of the invention, a machine such as a lathe is provided which has advantages over the prior art. In particular the number of components is able to be reduced as it is not necessary to have separate casings for the head stock and the motor, there is no need for pulleys and the number of bearings is reduced. Also belts are not required. By using a switch reluctance motor adequate power can be achieved over a wide range of speeds.

What we claim is:

1. A motor driven machine, the machine including a machine spindle and a switch reluctance motor having a motor spindle, the construction being such that the longitudinal axis of the motor spindle and the longitudinal axis of the machine spindle lie on substantially the same axis.

2. A motor driven machine as claimed in claim 1, wherein the machine is a lathe and the lathe includes a bed and a headstock, the longitudinal axis of the motor spindle and the longitudinal axis of the head stock spindle lying on substantially the same axis.

3. A motor driven machine as claimed in claim 2, wherein the head stock spindle and the motor spindle comprise a single spindle.

4. A motor driven machine substantially as herein described with reference to the accompanying drawings.
